(19) United States
(12) Patent Application Publication
(10) Pub. No.: US 2022/0105546 A1
(43) Pub. Date: Apr. 7, 2022

(54) Cyclonic Steam Cleaning Apparatus and Methods of Using the Same

(71) Applicant: Clinton D. Nelson, Wauconda, IL (US)

(72) Inventor: Clinton D. Nelson, Wauconda, IL (US)

(21) Appl. No.: 17/065,259

(22) Filed: Oct. 7, 2020

(51) Int. Cl. B08B 3/10; B08B 3/02

(52) U.S. Cl. CPC B08B 3/106; B08B 2203/007; B08B 3/02

(57) ABSTRACT

The present invention relates to a cleaning apparatus comprising steam having an induced cyclonic rotation emanating from a tapered nozzle. Specifically, the present invention comprises an element within a tube near or otherwise adjacent to a tapered nozzle from which steam emanates. As the steam passes the element, a rotation is induced in the steam causing it to rotate upon exiting the tapered nozzle. The induced cyclonic rotation of the steam exiting the tapered nozzle of a cleaning apparatus aids in the cleaning of objects. In an exemplary embodiment, the steam cleaning apparatus is a jewelry cleaning apparatus.

### TECHNICAL FIELD

The present invention relates to a cleaning apparatus comprising steam having an induced cyclonic rotation emanating from a nozzle. Specifically, the present invention comprises an element within a tube near or otherwise adjacent to a tapered nozzle from which steam emanates. As the steam passes the element, a rotation is induced in the steam causing it to rotate upon exiting the nozzle. The induced cyclonic rotation of the steam exiting the nozzle of a cleaning apparatus aids in the cleaning of objects. In an exemplary embodiment, the steam cleaning apparatus is a jewelry cleaning apparatus.

### BACKGROUND

It is, of course, generally known to generate steam from water for cleaning objects, such as jewelry and dental fields. Indeed, steam cleaning is useful as the high pressure of steam can be used to clean grunge and grime from objects through the force of the steam. In addition, the high temperature of the steam is useful for killing microbes, including bacteria, viruses, fungi, and the like. For jewelry and dental objects, steam cleaning is fairly standard, as the high pressure allows for the cleaning of the jewelry and/or dental objects, especially in difficult to reach places that are typical of jewelry and/or dental objects. In addition, because jewelry is typically worn close to the body, and dental objects obviously within the mouth, microbes can easily thrive due to various factors, such as cast-off skin cells, oils, food and dirt and grime that may accumulate on or otherwise collect on or within the jewelry and/or dental objects.

Typical steam cleaning apparatuses include some kind of boiler for raising the temperature of water, and a series of tubes through which generated steam may traverse. An exit on an end of a tube that is in communication with the boiler may accelerate the steam to very high velocity, aiding in the cleaning power of the steam. However, typically tubes provide an unimpeded pathway from the boiler to the exit. Steam emanating from the exit typically travels in a linear path from the exit.

Heretofore, if additional cleaning power is desired, it would be typical to add more energy to the system, thereby increasing the pressure of the steam generated within the boiler and, therefore, emanating from the exit. However, increasing the steam pressure within a cleaning system may be dangerous, as increased pressures can cause failures within the system, possible leading to damage and/or user injury. Moreover, adding energy to a system comes at an increased cost of operation.

A need, therefore, exists for an improved steam cleaning apparatus. Specifically, a need exists for an improved steam cleaning apparatus having additional cleaning power to aid in cleaning objects. More specifically, a need exists for an improved steam cleaning apparatus that generates additional cleaning power without requiring an increase in steam pressure and/or additional energy within the steam cleaning apparatus.

Moreover, a need exists for an improved steam cleaning apparatus that is useful to clean jewelry. More specifically, a need exists for an improved steam cleaning apparatus that allows a user to properly clean items of jewelry without causing damage thereby. More specifically, a need exists for an improved steam cleaning apparatus that induces cyclonic rotation in a steam pathway emanating from a cleaning nozzle that aids in cleaning the items of jewelry.

### SUMMARY OF THE INVENTION

The present invention relates to a cleaning apparatus comprising steam having an induced cyclonic rotation emanating from a nozzle. Specifically, the present invention comprises an element within a tube near or otherwise adjacent to a tapered nozzle from which steam emanates. As the steam passes the element, a rotation is induced in the steam causing it to rotate upon exiting the nozzle. The induced cyclonic rotation of the steam exiting the nozzle of a cleaning apparatus aids in the cleaning of objects. In an exemplary embodiment, the steam cleaning apparatus is a jewelry cleaning apparatus.

To this end, in an embodiment of the present invention, a steam exit tube system for a steam cleaning machine apparatus is provided. The steam exit tube system comprises: a steam exit tube configured to extend from a steam cleaning machine; a tapered nozzle attached to an end of the steam exit tube; and a helical element disposed within the steam exit tube.

In an embodiment, the helical element is made from metal.

In an embodiment, the helical element is made from temperature-resilient polymeric material.

In an embodiment, the helical element is configured to induce a helical pathway to pressurized high temperature steam running through the steam exit tube and exiting the nozzle.

In an embodiment, the helical element is fixed in place within the steam exit tube.

In an embodiment, the helical element is adhered to the steam exit tube.

In an embodiment, the helical element is welded in place within the steam exit tube.

In an embodiment, the helical element is positioned within the nozzle.

In an embodiment, the helical element is positioned partially within the nozzle.

In an embodiment, the helical element comprises at least a 360 degree helical rotation.

In an alternate embodiment of the present invention, a steam cleaning machine apparatus is provided. The steam cleaning machine apparatus comprises the steam exit tube system as described herein.

In an embodiment, the steam cleaning apparatus is a jewelry cleaning apparatus.

In an alternate embodiment of the present invention, a method of cleaning objects is provided. The method comprises the steps of: providing a steam cleaning apparatus, wherein the steam cleaning apparatus comprises a steam exit tube system comprising: a steam exit tube configured to extend from a steam cleaning machine; a nozzle attached to an end of the steam exit tube; and a helical element disposed within the steam exit tube; placing an object adjacent the nozzle for cleaning; activating the steam cleaning apparatus to generate pressurized high temperature steam; inducing a helical path in the pressurized high temperature steam with the helical element within the steam exit tube; and cleaning the object adjacent the nozzle with the pressurized high temperature steam in the helical path.

It is, therefore, an advantage and objective of the present invention to provide an improved steam cleaning apparatus.

Specifically, it is an advantage and objective of the present invention to provide an improved steam cleaning apparatus having additional cleaning power to aid in cleaning objects.

More specifically, it is an advantage and objective of the present invention to provide an improved steam cleaning apparatus that generates additional cleaning power without requiring an increase in steam pressure and/or additional energy within the steam cleaning apparatus.

Moreover, it is an advantage and objective of the present invention to provide an improved steam cleaning apparatus that is useful to clean jewelry.

More specifically, it is an advantage and objective of the present invention to provide an improved steam cleaning apparatus that allows a user to properly clean items of jewelry without causing damage thereby.

More specifically, it is an advantage and objective of the present invention to provide an improved steam cleaning apparatus that induces cyclonic rotation in a steam pathway emanating from a cleaning nozzle that aids in cleaning the items of jewelry.

Additional features and advantages of the present invention are described in, and will be apparent from, the detailed description of the presently preferred embodiments and from the drawings.

### BRIEF DESCRIPTION OF THE DRAWINGS

The drawing FIGURES depict one or more implementations in accord with the present concepts, by way of example only, not by way of limitations. In the FIGURES, like reference numerals refer to the same or similar elements.

FIG. 1 illustrates a perspective view of a jewelry cleaning apparatus having a close-up cut-away view of a tapered nozzle having a spiral element disposed therein in an embodiment of the present invention.

### DETAILED DESCRIPTION OF THE PRESENTLY PREFERRED EMBODIMENTS

The present invention relates to a cleaning apparatus comprising steam having an induced cyclonic rotation emanating from a nozzle. Specifically, the present invention comprises an element within a tube near or otherwise adjacent to a tapered nozzle from which steam emanates. As the steam passes the element, a rotation is induced in the steam causing it to rotate upon exiting the nozzle. The induced cyclonic rotation of the steam exiting the nozzle of a cleaning apparatus aids in the cleaning of objects. In an exemplary embodiment, the steam cleaning apparatus is a jewelry cleaning apparatus.

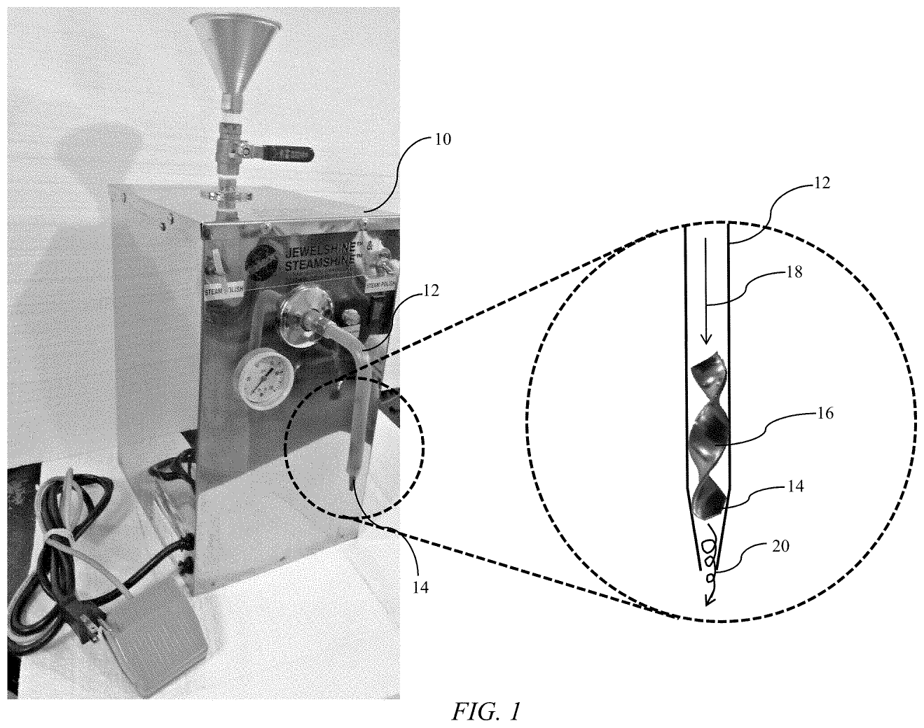

Now referring to the FIGURE, wherein like numerals refer to like parts, FIG. 1 illustrates a perspective view of a cleaning apparatus 10 having a tapered nozzle, in an exemplary embodiment of the present invention. The jewelry cleaning apparatus 10 comprises a steam exit tube 12 having a tapered (i.e., frustoconical) nozzle 14 on an end thereof. In normal function, the cleaning apparatus 10 comprises a boiler for generating pressurized steam, whereby the pressurized steam is forced through the steam exit tube 12, accelerating through the nozzle 14 on the end thereof. The cleaning apparatus 10 may be used to clean objects, such as, for example, jewelry objects, dental objects (such as in the dental laboratory or dental office setting), or the like.

As illustrated in FIG. 1, a spiral element 16 (also referred to as helical element 16) may be disposed within the steam exit tube 12. The spiral element 16 may preferably be made of metal, although the same may also be made from temperature-resilient polymeric material, or other like material that may withstand the high temperatures and pressures of the steam flowing therethrough. The spiral element 16 may preferably be placed adjacent to the nozzle 14, but may be placed in any location within the steam exit tube 12. Moreover, the spiral element 16 may further be disposed within or partially within the nozzle 14.

As high temperature pressurized steam flows through the steam exit tube 12, represented by arrow 18, it typically travels in, generally, a straight line as it exits the nozzle 14. The spiral element induces a spiral, helical, or cyclonic pathway for the steam, represented by spiral arrow 20, as the pressurized high temperature steam exits the nozzle 14. The tapered nozzle further accelerates the pressurized high temperature steam, and in conjunction with the cyclonic pathway of the steam, greatly accelerates the speed and turbulence of the steam exiting the tapered nozzle 14.

The spiral element 16 may have a spiral shape with sufficient turns therein to induce a spiral rotation in the pathway of the high temperature steam. A spiral or cyclonic pathway may be introduced with any number of rotations of the spiral element 16. For example, a spiral element having merely a 90 degree rotation may be sufficient to introduce the cyclonic pathway thereto. As illustrated in FIG. 1, the spiral element 16 comprises one full 360 degree helical rotation, although the number of rotations is not limited, and the present invention should not be limited as described herein. Preferably, the spiral element 16 may have roughly about 2.5 rotations per inch, although, as previously stated, any number of rotations may be utilized to introduce the cyclonic pathway to the steam.

The spiral element 16 may be adhered, welded, or otherwise fixed in position as desired so that the same does not come loose during operation thereof. Alternatively, the spiral element 16 may simply be wedged in place, such as wedged partially within the nozzle 14 to prevent movement of the same during operation thereof. As the steam flows out from the steam exit tube 12, the pressure of the same generally may keep the spiral element 16 in its position, thereby inducing the steam to exit the nozzle 14 in a spiral or helical pathway.

The spiral or helical pathway induced into the pressurized and high temperature steam may allow for easier cleaning of objects, such as jewelry, dental objects, or other like objects, therebeneath.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are non-limiting, and it should be noted that claim limitations presented herein are not meant to describe the invention as a whole. Moreover, the invention illustratively disclosed herein suitably may be practiced in the absence of any element which is not specifically disclosed herein.

1: A steam exit tube system for a steam cleaning machine comprising:
a steam exit tube configured to extend from a steam cleaning machine, wherein the steam cleaning machine is configured to clean jewelry, the steam cleaning machine comprising a boiler for generating pressurized steam wherein the steam exits from the steam cleaning machine through the steam exit tube;
a frustoconical nozzle attached to an end of the steam exit tube; and
a helical element disposed within the steam exit tube, wherein the helical element is configured to induce a spiral pathway to the pressurized steam as it exits the frustoconical nozzle.

2: The steam exit tube system of claim 1 wherein the helical element is made from metal.

3: The steam exit tube system of claim 1 wherein the helical element is made from polymeric material.

4. (canceled)

5: The steam exit tube system of claim 1 wherein the helical element is fixed in place within the steam exit tube.

6: The steam exit tube system of claim 5 wherein the helical element is adhered to the steam exit tube.

7: The steam exit tube system of claim 5 wherein the helical element is welded in place within the steam exit tube.

8: The steam exit tube system of claim 1 wherein the helical element is positioned within the tapered nozzle.

9: The steam exit tube system of claim 1 wherein the helical element is positioned partially within the tapered nozzle.

10: The steam exit tube system of claim 1 wherein the helical element comprises at least a 360 degree helical rotation.

11: A steam cleaning apparatus comprising the steam exit tube system of claim 1.

12. (canceled)

13: A method of cleaning objects comprising the steps of:
providing a steam cleaning apparatus, wherein the steam cleaning apparatus comprises a steam exit tube system comprising:
a steam exit tube configured to extend from a steam cleaning machine;
a tapered nozzle attached to an end of the steam exit tube; and
a helical element disposed within the steam exit tube;
placing an object adjacent the tapered nozzle for cleaning;
activating the steam cleaning apparatus to generate pressurized high temperature steam;
inducing a helical path in the pressurized high temperature steam with the helical element within the steam exit tube; and
cleaning the object adjacent the tapered nozzle with the pressurized high temperature steam in the helical path.

14: The method of claim 13 wherein the helical element is made from metal or temperature-resilient polymeric material.

15: The method of claim 13 wherein the helical element is fixed in place within the steam exit tube.

16: The method of claim 13 wherein the helical element is adhered to the steam exit tube.

17: The method of claim 13 wherein the helical element is welded in place within the steam exit tube.

18: The method of claim 13 wherein the helical element is positioned within the tapered nozzle.

19: The method of claim 13 wherein the helical element is positioned partially within the tapered nozzle.

20: The method of claim 13 wherein the helical element comprises at least a 360 degree helical rotation.
